(19) United States
(12) Patent Application Publication
(10) Pub. No.: US 2025/0364642 A1
(43) Pub. Date: Nov. 27, 2025

(54) POWER STORAGE DEVICE, POWER STORAGE DEVICE CASE, AND POWER STORAGE DEVICE EXTERIOR MATERIAL

(71) Applicant: DNP HIGH-PERFORMANCE MATERIALS HIKONE CO., LTD., Hikone-shi (JP)

(72) Inventors: Daisuke NAKAJIMA, Hikone-shi (JP); Terutoshi KUMAKI, Hikone-shi (JP)

(73) Assignee: DNP HIGH-PERFORMANCE MATERIALS HIKONE CO., LTD., Hikone-shi (JP)

(21) Appl. No.: 19/294,311

(22) Filed: Aug. 8, 2025

Related U.S. Application Data
(63) Continuation of application No. PCT/JP2024/004651, filed on Feb. 9, 2024.

(30) Foreign Application Priority Data
Feb. 10, 2023 (JP) 2023-019411

(51) Int. Cl. H01M 50/129; H01M 50/105; H01M 50/119; H01M 50/121

(52) U.S. Cl. CPC H01M 50/129; H01M 50/105; H01M 50/119; H01M 50/121

(57) ABSTRACT

A power storage device case having excellent insulating and heat-dissipating properties is provided. The power storage device case includes a case body having a recessed housing portion and a flange provided around the periphery of the housing portion. The case body is made of a power storage device exterior material. The exterior material includes a resin base layer, a metal foil layer laminated on the inner surface side of the base layer, a gas barrier layer laminated on the inner surface side of the metal foil layer, and a sealant layer laminated on the inner surface side of the gas barrier layer. The gas barrier layer and the sealant layer are made of resins that are thermally fusible to each other. An opening portion is provided in the sealant layer to expose the gas barrier layer inside the housing portion.

### CROSS-REFERENCE TO RELATED APPLICATIONS

The present application is a continuation application of International Application No. PCT/JP2024/004651, filed on Feb. 9, 2024, which claims priority to Japanese Patent Application No. 2023-019411, filed on Feb. 10, 2023, the contents of which are incorporated herein by reference in its entirety.

### BACKGROUND OF THE INVENTION

### Field of the Invention

The present disclosure relates to a power storage device, such as an all-solid-state battery, which is used as a high-power battery for vehicle applications, a battery for portable devices such as mobile electronic equipment, or a battery for storing regenerative energy, and further relates to a power storage device case and a power storage device exterior material used in such a power storage device.

### Description of the Related Art

In conventionally widely used lithium-ion secondary batteries, since a liquid electrolyte is used, there has been a risk that the separator may be damaged due to liquid leakage or the formation of dendrites. In some cases, this may result in ignition or the like due to short circuiting.

In contrast, an all-solid-state battery is a battery that uses a solid electrolyte, so liquid leakage and the formation of dendrites do not occur, nor is the separator damaged. Therefore, concerns such as ignition due to separator damage are no longer present, and such batteries have attracted considerable attention from the viewpoint of safety and the like.

The typical all-solid-state battery is constructed such that an all-solid-state battery cell including an electrode active material, a solid electrolyte, and other components is sealed inside an exterior material serving as a casing. In this all-solid-state battery, as research on solid electrolytes progresses, performance requirements for the exterior material that differ from those for exterior materials of conventional batteries using liquid electrolytes have gradually emerged, and various exterior materials have been proposed to satisfy performance requirements for all-solid-state batteries.

An exterior material for an all-solid-state battery has, as a basic structure, a metal foil layer and a heat-fusible layer (sealant layer) laminated on the inner side of the metal foil layer and is configured to seal an all-solid-state battery cell by heat-fusing the sealant layer.

For example, the exterior material for an all-solid-state battery disclosed in Patent Document 1 includes a protective film interposed between a metal foil layer and a sealant layer, and a sealant layer having high hydrogen sulfide gas permeability is used. Furthermore, in the exterior material for an all-solid-state battery disclosed in Patent Document 2, a sealant layer having low hydrogen sulfide gas permeability is used. In addition, in the exterior material for an all-solid-state battery disclosed in Patent Document 3, a sealant layer that absorbs gas is used. Further, in the exterior material for an all-solid-state battery disclosed in Patent Document 4, a vapor-deposited film layer is laminated on the inner surface of the sealant layer.

### PRIOR ART DOCUMENTS

### Patent Documents

Patent Document 1: Japanese Patent No. 6777276

Patent Document 2: Japanese Patent No. 6747636

Patent Document 3: Japanese Unexamined Patent Application Publication No. 2020-187855

Patent Document 4: Japanese Unexamined Patent Application Publication No. 2020-187835

### SUMMARY OF THE INVENTION

### Problems to be Solved by the Invention

However, the conventional all-solid-state batteries have a problem in that gases, such as hydrogen sulfide gas, generated by a reaction between the solid electrolyte and moisture, may leak.

On the other hand, in all-solid-state batteries, the exchange of electrons (ions) occurs through the solid electrolyte during charging and discharging. Therefore, compared with liquid electrolytes, all-solid-state batteries tend to exhibit higher internal resistance and increased heat generation. However, it is considered that the performance of all-solid-state batteries is not affected even in high-temperature environments. As a result, including Patent Documents 1 to 4, countermeasures for high temperatures (cooling performance) have not been discussed. Nevertheless, as battery technologies continue to evolve toward higher output and capacity, it is fully anticipated that there will be a future demand for improved cooling performance even in all-solid-state batteries.

The above describes the problems in all-solid-state batteries. However, similar problems may also arise in other power storage devices.

Preferred embodiments of the present disclosure have been made in view of the above and/or other problems in the related technologies. The preferred embodiments of the present disclosure are capable of significantly improving existing methods and/or devices.

The present disclosure has been made in view of the above problems. An object of the present disclosure is to provide a power storage device, a power storage device case, and a power storage device exterior material that are configured to prevent the leakage of gases, such as hydrogen sulfide gas, while ensuring sufficient cooling performance.

Other objects and advantages of the present disclosure will become apparent from the following preferred embodiments.

### Means for Solving the Problems

In order to solve the above problems, the present disclosure provides the following means.

[1] A power storage device case comprising:
a case body, the case body being provided with a recessed housing portion and a flange provided on an outer periphery of the housing portion,
wherein the case body is made of a power storage device exterior material,
wherein the power storage device exterior material includes a base layer made of resin, a metal foil layer laminated on an inner surface side of the base layer, a gas barrier layer laminated on an inner surface side of the metal foil layer, and a sealant layer laminated on an inner surface side of the gas barrier layer,
wherein the gas barrier layer and the sealant layer are made of resins that are thermally bondable to each other, and
wherein the sealant layer is provided with an opening portion for exposing the gas barrier layer to an inside of the housing portion.

[2] A power storage device comprising:
the case body configured to be used in the power storage device case as recited in the above-described Item [1];
a power storage device cell housed in the housing portion of the case body; and
a sealing member heat-sealed to the flange of the case body in a state in which an opening portion of the housing portion in the case body is closed.

[3] The power storage device as recited in the above-described Item [2],
wherein the sealing member includes a base layer made of resin, a metal foil layer laminated on an inner surface side of the base layer, a gas barrier layer laminated on an inner surface side of the metal foil layer, and a sealant layer laminated on an inner surface side of the gas barrier layer, the gas barrier layer and the sealant layer being made of resins thermally bondable to each other, and
wherein the sealant layer in the sealing member is provided with an opening portion for exposing the gas barrier layer of the sealing member to the housing portion.

[4] The power storage device as recited in the above-described Item [2] or [3],
wherein a seal strength at an edge portion of a heat-sealed portion between the flange and the sealing member, the edge portion being located on a housing portion side, is set to 20 N/15 mm or more.

[5] A power storage device exterior material configured to be used in the power storage device case as recited in the above-described Item [1],
wherein the power storage device exterior material has a sheet-like shape, and
wherein the power storage device exterior material is provided with an opening-intended portion to serve as the opening portion and a flange-intended portion to serve as the flange.

6. The power storage device exterior material as recited in the above-described Item [5],
wherein an adhesive layer is provided between the gas barrier layer and the sealant layer, and
wherein the opening-intended portion is configured as an adhesive-free portion in which the adhesive layer is not present.

[7] The power storage device exterior material as recited in the above-described Item [5] or [6],
wherein the gas barrier layer and the sealant layer are made of a polyolefin-based resin.

### Effects of the Invention

According to the power storage device case of the invention [1], a gas barrier layer is provided between the metal foil layer and the sealant layer, and an opening portion is formed in the sealant layer. When a power storage device is fabricated by sealing a power storage device cell, since an opening portion without the sealant layer is provided, heat generated from the power storage device cell is efficiently transferred to and dissipated from the metal foil layer via the opening portion and the gas barrier layer without being blocked by the sealant layer, whereby sufficient heat dissipation and cooling performance can be ensured. Further, in the invention, since the gas barrier layer is disposed on the inner surface side of the metal foil layer, even when hydrogen sulfide gas or the like is generated as a result of a reaction between the solid electrolyte of the power storage device cell and moisture in the outside air, leakage of the gas can be prevented by the gas barrier layer. Moreover, in the invention, since the gas barrier layer and the sealant layer are made of resins that are thermally bondable to each other, when a resin accumulation portion is formed by the sealant layer during heat sealing, resin also melts and flows out from the gas barrier layer, whereby a large resin accumulation portion is formed. This resin accumulation portion can be reliably brought into close contact with the gas barrier layer, and even if peel stress occurs, unintended interlayer delamination between the gas barrier layer and the sealant layer can be prevented, thereby ensuring sufficient seal strength (peel strength).

According to the power storage device of the invention [2], similarly to the above, a good external appearance can be ensured. In addition, while ensuring sufficient heat dissipation and cooling performance, leakage of gases, such as hydrogen sulfide gas, can be reliably prevented, and sufficient seal strength can be ensured.

According to the power storage device of the invention [3], since an opening portion is formed also in the sealant layer of the sealing member, heat dissipation and cooling performance can be further improved.

According to the power storage device of the invention [4], sufficient seal strength can be ensured more reliably.

According to the power storage device exterior material of the invention [5], similarly to the above, when a power storage device is fabricated, favorable appearance can be ensured. In addition, while ensuring sufficient heat dissipation and cooling performance, leakage of gases, such as hydrogen sulfide gas, can be reliably prevented, and sufficient seal strength can be ensured.

According to the power storage device exterior material of the invention [6], an opening portion in which the sealant layer is not present can be reliably formed.

According to the power storage device exterior material of the invention [7], when a power storage device is fabricated, seal strength can be further improved.

### BRIEF DESCRIPTION OF THE DRAWINGS

Some embodiments of the present disclosure are shown by way of example, and not limitation, in the accompanying figures.

FIG. 1 is a schematic cross-sectional view showing an all-solid-state battery as a power storage device according to an embodiment of the present disclosure.

FIG. 2 is an exploded perspective view schematically showing a battery case of the all-solid-state battery according to the embodiment.

FIG. 3 is a schematic cross-sectional view showing an exterior material in the all-solid-state battery according to the embodiment.

FIG. 4 is a schematic cross-sectional view for explaining a method of forming an opening portion in the exterior material according to the embodiment.

FIG. 5 is a schematic cross-sectional view showing a molding apparatus for forming a case body using the exterior material according to the embodiment.

FIG. 6 is a schematic cross-sectional view showing a state immediately before heat sealing according to the embodiment.

FIG. 7 is a schematic cross-sectional view showing a state immediately after heat sealing according to the embodiment.

FIG. 8A is a schematic cross-sectional view showing an all-solid-state battery according to a first modification of the present disclosure.

FIG. 8B is a schematic cross-sectional view showing an all-solid-state battery according to a second modification of the present disclosure.

FIG. 8C is a schematic cross-sectional view showing an all-solid-state battery according to a third modification of the present disclosure.

FIG. 9 is a schematic cross-sectional view for explaining a heat sealing method in examples and comparative examples.

### EMBODIMENTS FOR CARRYING OUT THE INVENTION

In the following paragraphs, some embodiments in the present disclosure will be described by way of example and not limitation. It should be understood based on this disclosure that various other modifications can be made by those in the art based on these illustrated embodiments.

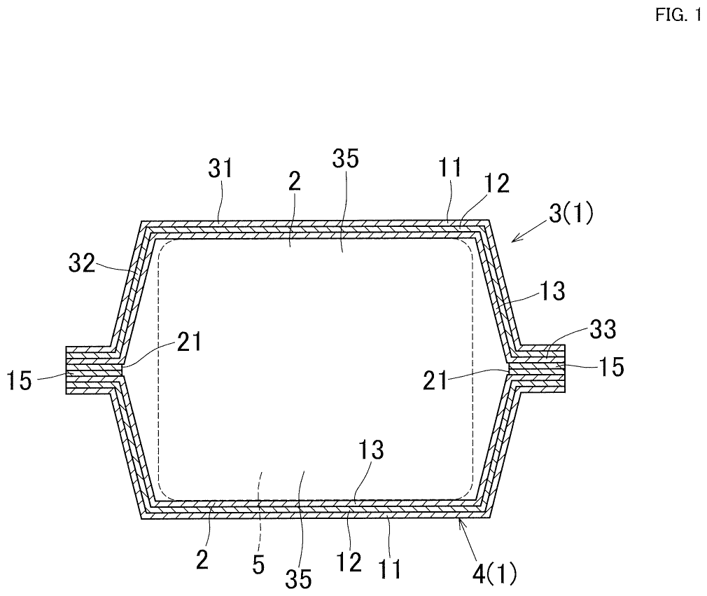

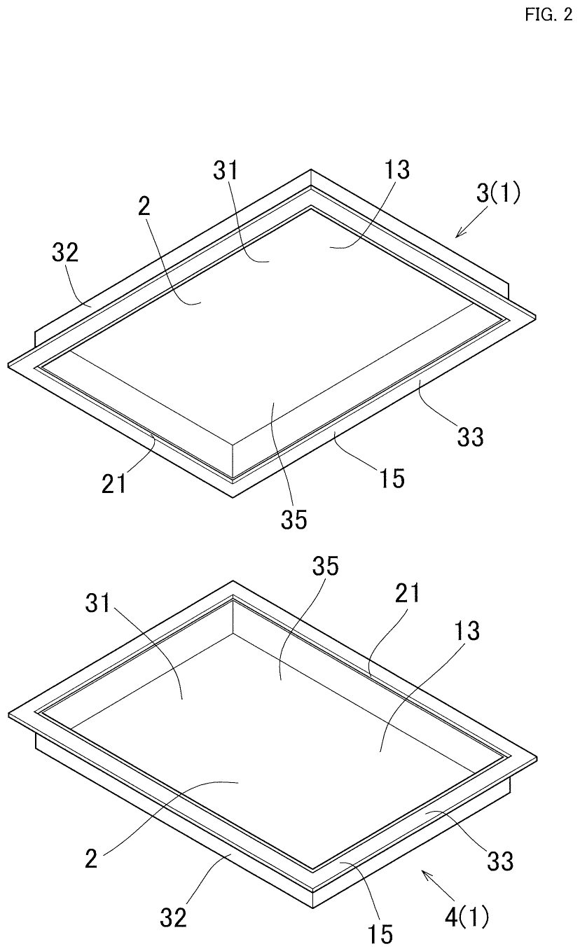

FIG. 1 is a schematic cross-sectional view showing an all-solid-state battery as a power storage device according to an embodiment of the present disclosure, and FIG. 2 is an exploded perspective view schematically showing a battery case of the all-solid-state battery according to the embodiment. As shown in both figures, the all-solid-state battery of this embodiment includes a case body 3 and a sealing member 4 serving as a battery case (casing), and an all-solid-state battery cell 5 that is housed and sealed in the battery case.

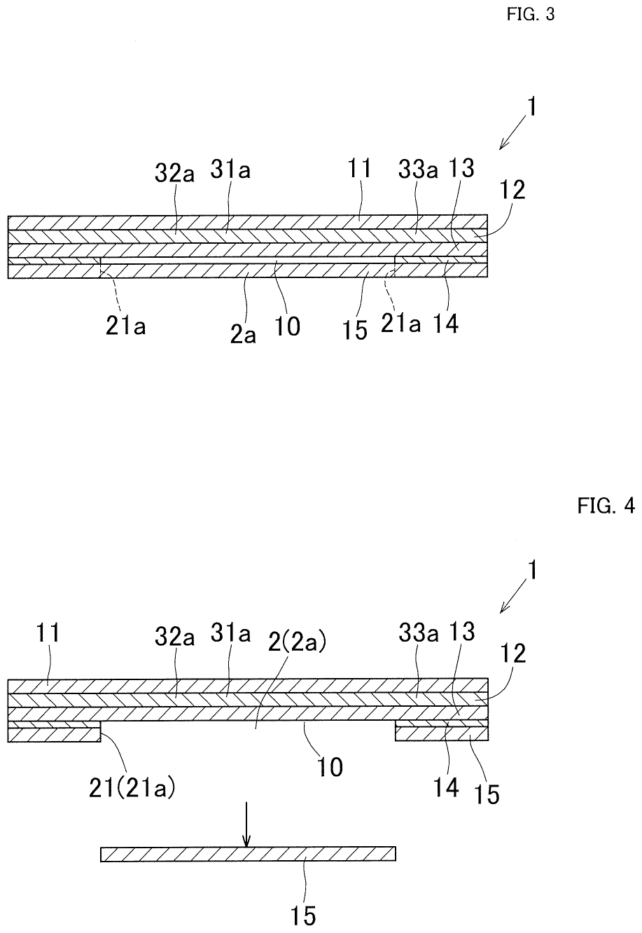

FIG. 3 is a schematic cross-sectional view showing an exterior material 1 used to form the case body 3 in the all-solid-state battery according to the embodiment. As shown in the figure, the exterior material 1 includes: a base layer 11 disposed on the outermost side; a metal foil layer 12 laminated and bonded to the inner surface side of the base layer 11 via an adhesive layer (first adhesive layer); a gas barrier layer 13 laminated and bonded to the inner surface side of the metal foil layer 12 via an adhesive layer (second adhesive layer); and a sealant layer 15 laminated and bonded to the inner surface side of the gas barrier layer 13 via an adhesive layer (third adhesive layer). In the present disclosure, when describing the positions of the respective layers of the exterior material 1 in terms of direction, the direction toward the base layer 11 (upper side in FIG. 3) is referred to as the outer side, and the direction toward the sealant layer 15 (lower side in FIG. 3) is referred to as the inner side.

It should be noted that the exterior material 1 used to form the sealing member 4 is obtained by simply inverting the exterior material 1 used to form the case body 3 upside down and has substantially the same configuration.

As shown in FIGS. 1 and 2, the case body 3 and the sealing member 4 are formed of molded articles of the exterior material 1, and integrally include: a recessed housing portion 35 formed in a concave shape; a bottom wall 31 forming a bottom surface (top surface) of the housing portion 35; a sidewall 32 forming a peripheral side surface of the housing portion 35; and a flange 33 provided on an outer periphery of the sidewall 32.

The all-solid-state battery cell 5 is housed in the housing portion 35 of the case body 3 and the sealing member 4, such that the sealant layers 15 of the flanges 33 of the case body 3 and the sealing member 4 are arranged to overlap each other. By thermally bonding (heat sealing) the overlapped sealant layers 15, the layers are integrated with each other, whereby an all-solid-state battery is fabricated in which the all-solid-state battery cell 5 is housed in a sealed state within the battery case (the case body 3 and the sealing member 4).

Further, in the case body 3 and the sealing member 4 of the all-solid-state battery, an opening portion 2 is formed by removing the sealant layer 15 and the adhesive layer 14 in a portion corresponding to the housing portion 35. In the sealing member 4 as well, an opening portion 2 is formed by removing the sealant layer 15 and the adhesive layer 14 in a portion corresponding to the housing portion 35. Through the opening portions 2 of the case body 3 and the sealing member 4, the gas barrier layer 13 of the exterior material 1 is exposed inside the housing portion 35 and is arranged so as to face the all-solid-state battery cell 5.

In the all-solid-state battery of this embodiment, although not illustrated, tab leads for extracting electricity are provided. This tab lead has one end (inner end) bonded and fixed to the all-solid-state battery cell 5 and is arranged such that an intermediate portion passes through a heat-sealed portion between the flange 33 of the case body 3 and the flange 33 of the sealing member 4, and the other end is drawn out to the outside.

Details of each part of the all-solid-state battery in this embodiment will be described below.

The base layer 11 of the exterior material 1 is formed of a heat-resistant resin film having a thickness of 5 μm to 50 μm. As the resin film used for the base layer 11, a stretched polyamide film, a stretched polyester film (PET, PBT, PEN, etc.), or a stretched polyolefin film (PE, PP, etc.) are preferably used.

The metal foil layer 12 has a thickness set from 5 μm to 120 μm and has a function of blocking penetration of oxygen and moisture from the surface (outer side). As the metal foil layer 12, an aluminum foil, a SUS foil (stainless steel foil), a copper foil, a nickel foil, and the like are preferably used. In this embodiment, the terms “aluminum,” “copper,” and “nickel” are used to include their alloys as well.

Further, by applying plating or a similar treatment to the metal foil layer 12, the risk of pinhole formation is reduced, and the barrier performance against oxygen and moisture can be further improved.

Furthermore, by performing a chemical conversion treatment, such as a chromate treatment, on the metal foil layer 12, corrosion resistance is further improved, thereby more reliably preventing the occurrence of defects, such as cracks or scratches. Additionally, adhesion to the resin is improved, which further enhances durability.

The sealant layer (heat-sealable resin layer) 15 has a thickness set from 20 μm to 100 μm and is formed of a heat-adhesive (heat-fusible) resin film. Examples of resins preferably used in the sealant layer 15 include polyethylene (LLDPE, LDPE, HDPE); polyolefins such as polypropylene; olefin-based copolymers; acid-modified products thereof; and ionomers. Non-stretched polypropylene (CPP, IPP) is one such example.

As the sealant layer 15, in consideration of extracting electricity using tab leads, namely ensuring sealability and adhesiveness with the tab leads, it is preferable to use a polypropylene-based resin, such as a non-stretched polypropylene film (e.g., CPP or IPP).

In this embodiment, it is preferable to set the thickness (original thickness) of the gas barrier layer 13 to 3 μm to 50 μm, and more preferably to 10 μm to 50 μm. That is, when the thickness of the gas barrier layer 13 is set within this range, it is possible to reliably ensure the above-described effects of suppressing the permeation of hydrogen sulfide gas and water vapor gas. In addition, even if the sealant layer 15 melts and flows out due to thermal bonding, insulation can be reliably ensured by the gas barrier layer 13. In other words, if the gas barrier layer 13 is too thin, there is a risk that the gas permeation suppression effect and insulation cannot be ensured, which is undesirable. Conversely, if the gas barrier layer 13 is too thick, not only is it impossible to reduce the thickness of the exterior material 1, but the effect of increasing the thickness more than necessary cannot be sufficiently ensured, which is also undesirable.

As the resin used to form the gas barrier layer 13, a resin selected from a group consisting of polyolefins such as polyethylene (LLDPE, LDPE, HDPE) and polypropylene; cyclic polyolefins; olefin-based copolymers; acid-modified products thereof; and ionomers is preferably used. Examples include non-stretched polypropylene (e.g., CPP or IPP).

The resin constituting the gas barrier layer 13 may be the same resin or a similar type of resin as the resin used to form the sealant layer 15.

Furthermore, in this embodiment, it is preferable that the melting points of the resin used to form the gas barrier layer 13 and the resin used to form the sealant layer 15 be in the range of 100° C. to 180° C. It is more preferable that the difference between their melting points be 30° C. or less. That is, since the exterior material is heat-sealed at a temperature 20° C. to 40° C. higher than the melting point of the sealant layer 15 (heat-fusible resin layer), both the gas barrier layer 13 and the sealant layer 15 can be thermally bonded. This promotes the formation of resin accumulation and ensures good seal strength.

In this embodiment, it is preferable that the resin used to form the barrier layer 13 have a predetermined hydrogen sulfide (H₂S) gas permeability. Specifically, the gas barrier layer 13 is preferably formed of a resin having a hydrogen sulfide gas permeability of 15 {cc·mm/(m²·D·MPa)} or less, more preferably 10 {cc·mm/(m²·D·MPa)} or less, and still more preferably 4.0 {cc·mm/(m²·D·MPa)} or less, as measured in accordance with JIS K7126-1. That is, when the hydrogen sulfide gas permeability of the gas barrier layer 13 is set to be equal to or less than the above-specified value, it is possible to prevent hydrogen sulfide gas, which is generated by a reaction between the solid electrolyte material and moisture in the outside air, from leaking to the outside through the gas barrier layer 13. In other words, if the hydrogen sulfide gas permeability of the gas barrier layer 13 is too high, the generated hydrogen sulfide gas may leak to the outside through the exterior material 1 (the gas barrier layer 13), which is undesirable.

For reference, the “D” included in the unit of hydrogen sulfide gas permeability stands for “Day (24 h).”

In this embodiment, it is preferable to use a resin film as the gas barrier layer 13. That is, since the entire film serves as the barrier layer, unlike a vapor-deposited film or the like, no barrier cracks occur, thereby improving the barrier performance.

The gas barrier layer 13 of this embodiment has good insulation properties. Even after the all-solid-state battery cell 5 is sealed with the case body 3 and the sealing member 4, which serve as the exterior material 1 of this embodiment, good insulation performance can still be ensured.

In this embodiment, it is preferable that the gas barrier layer 13 have an arithmetic mean height Sa, as surface roughness, in the range of 0.04 μm to 1.5 μm. That is, when the surface roughness of the gas barrier layer 13 is within the above-described range, slidability with respect to a forming punch 7 is improved, thereby enhancing formability, which is desirable. In other words, if the arithmetic mean height Sa is less than 0.04 μm, the contact area with the forming punch 7 becomes large, resulting in increased frictional resistance and possible deterioration in formability, which is undesirable. On the other hand, if the arithmetic mean height Sa exceeds 1.5 μm, adhesion defects may occur in the adhesive layer 14, leading to reduced adhesiveness, which is also undesirable.

In this embodiment, as the adhesive layers used to bond between the base layer 11 and the metal foil layer 12 (first adhesive layer), between the metal foil layer 12 and the gas barrier layer 13 (second adhesive layer), and between the gas barrier layer 13 and the sealant layer 15 (third adhesive layer) 14, dry lamination adhesives, such as polyurethane-based adhesives, acrylic-based adhesives, polyacrylic acid ester-based adhesives, modified polypropylene-based adhesives, polyester-based adhesives, polyamide-based adhesives, and epoxy-based adhesives, are suitably used. The thicknesses of the first to third adhesive layers are preferably set in the range of 1 μm to 6 μm.

For the second adhesive layer, instead of using an adhesive, it is also possible to laminate a resin for forming the heat-resistant gas barrier layer and an adhesive resin, such as a polyolefin-based resin (e.g., polyolefin, carboxylic acid-modified polyolefin, metal-modified polyolefin), polyvinyl acetate-based resin, (meth)acrylic resin, and amino resin, onto the metal foil layer by co-extruding them (extrusion lamination method). Alternatively, a method may be employed in which a laminate obtained in advance by laminating the adhesive resin and the heat-resistant gas barrier layer is laminated onto the metal foil layer by a thermal lamination method. Another method may involve bonding the metal foil layer and the heat-resistant gas barrier layer by pouring a molten adhesive resin between them (sand lamination method), among others.

In this embodiment, the opening portions 2 of the case body 3 and the sealing member 4 are provided such that their outer peripheral edge portions 21 are located on the flange 33 of the case body 3 and the sealing member 4.

Here, in the present disclosure, the outer peripheral edge portion 21 of the opening portion 2 may be provided on the sidewall 32 of the case body 3 or the sealing member 4, as will be described in detail later, or may be provided on the bottom wall (top wall) 31 of the case body 3 and the sealing member 4. However, in the present disclosure, it is preferable to provide the outer peripheral edge portions 21 of the opening portions 2 on the flange 33 of the case body 3 and the sealing member 4, as in this embodiment.

In this embodiment, in the opening portion 2 formed in the case body 3 and the sealing member 4, no adhesive layer 14 for bonding the sealant layer 15 to the gas barrier layer 13 is provided, and the gas barrier layer 13 is exposed on the inner side through the opening portion 2. In the state in which the all-solid-state battery is fabricated, the gas barrier layer 13 is arranged so as to face the upper surface, peripheral side surfaces, and lower surface of the all-solid-state battery cell 5.

In this embodiment, no adhesive layer 14 is provided in the opening portion 2. However, the present disclosure is not limited to this, and the adhesive layer 14 may be partially provided in at least part of the opening portion 2. Nevertheless, as in this embodiment, the absence of the adhesive layer 14 can enhance heat dissipation.

Next, a method for manufacturing the exterior material 1 in this embodiment will be described. In the present disclosure, it should be understood that the method for manufacturing the exterior material 1 is not limited to the method described below. The same applies to the methods for manufacturing the case body 3 and the all-solid-state battery, which will be described later.

In this embodiment, first, a laminate without the sealant layer is manufactured, for example, by a dry lamination method. That is, a resin film for the base layer 11 is bonded to the outer surface of a metal foil (metal foil layer 12) that has undergone, as needed, a surface treatment or a chemical conversion treatment, via an adhesive, and a resin film for the gas barrier layer 13 is bonded to the inner surface of the metal foil via an adhesive. Thus, a laminate without the sealant layer is formed. In this laminate, the metal foil layer 12 and the gas barrier layer 13 are laminated on the inner surface side of the base layer 11.

It is also possible to fabricate the laminate without the sealant layer by an extrusion lamination method. That is, the above-described laminate may be fabricated by extruding and laminating a resin composition for the base layer 11 and a resin composition for the gas barrier layer 13 onto the outer and inner surfaces, respectively, of the metal foil.

Next, a resin film for the sealant layer 15 is bonded to the inner surface (the inner surface of the gas barrier layer 13) of the above-described laminate without the sealant layer via an adhesive (adhesive layer 14), thereby forming the sealant layer 15. At this stage, adjustments are made so that the portion of the sealant layer 15 corresponding to the opening-intended portion 2a, where the opening portion 2 is to be formed, can be reliably peeled off and removed by the following method.

As shown in FIG. 3, in a first formation method, when forming the sealant layer 15 on the gas barrier layer 13, an adhesive serving as the adhesive layer 14 is applied to the inner surface of the resin film functioning as the gas barrier layer 13 using a gravure roll or the like, and a resin film serving as the sealant layer 15 is bonded via the adhesive layer 14. However, when applying the adhesive to the gas barrier layer 13 using the gravure roll or the like, an adhesive-free portion 10 where no adhesive is applied is previously formed at the opening-intended portion 2a. Then, a resin film for the sealant layer is bonded to the gas barrier layer 13 having the adhesive-free portion 10 and dried.

Thereafter, as shown in FIG. 4, the opening-intended portion 2a of the sealant layer 15 at the adhesive-free portion 10 is cut out using a laser cutter, a rotary blade, or the like, such as laser cutting, thereby forming the opening portion 2 (first formation method).

As a second formation method, before applying an adhesive to the gas barrier layer 13, a release paper is temporarily attached to a region of the gas barrier layer 13 corresponding to the opening-intended portion 2a. In that state, an adhesive is applied to the gas barrier layer 13 using a gravure roll or the like, and a resin film for the sealant layer 15 is bonded and dried.

Thereafter, the opening-intended portion 2a of the sealant layer 15 corresponding to the temporarily fixed release paper portion is cut out together with the adhesive and the release paper using laser punching, a rotary blade, or the like, thereby forming the opening portion 2. When employing this second formation method, only the resin film for the sealant layer may be removed, or both the resin film for the sealant layer and the adhesive may be removed, or the resin film for the sealant layer, the adhesive, and the release agent may be removed. In other words, the release agent or adhesive may optionally be left in place.

As another formation method, it is also conceivable to form a through-hole as the opening portion 2 in the resin film for the sealant layer 15 before bonding it to the gas barrier layer 13, and to bond the resin film for the sealant layer, which includes the opening portion, to the gas barrier layer 13 via an adhesive (another formation method). However, in this alternative formation method, it is difficult to apply the adhesive uniformly, and it is also difficult to bond the resin film for the sealant layer, including the opening portion, accurately and precisely. Therefore, in this embodiment, it is preferable to adopt the above-described first and second formation methods.

Here, as shown in FIGS. 3 and 4, the sheet-shaped exterior material 1 prior to mold forming includes a bottom wall-intended portion 31a, which is a portion intended to become the bottom wall 31, a sidewall-intended portion 32a, which is a portion intended to become the sidewall 32, and a flange-intended portion 33a, which is a portion intended to become the flange 33.

In this embodiment, the outer peripheral edge portion 21a of the opening-intended portion 2a is set within the range of the flange-intended portion 33a.

In this embodiment, the outer peripheral edge portion 21a of the opening-intended portion 2a is set in the flange-intended portion 33a. However, as will be described later, in the present disclosure, the outer peripheral edge portion 21a of the opening-intended portion 2a may instead be provided in the sidewall-intended portion 32a or the bottom wall-intended portion 31a.

It should be noted that the flange-intended portion 33a includes a heat-sealed portion for heat sealing.

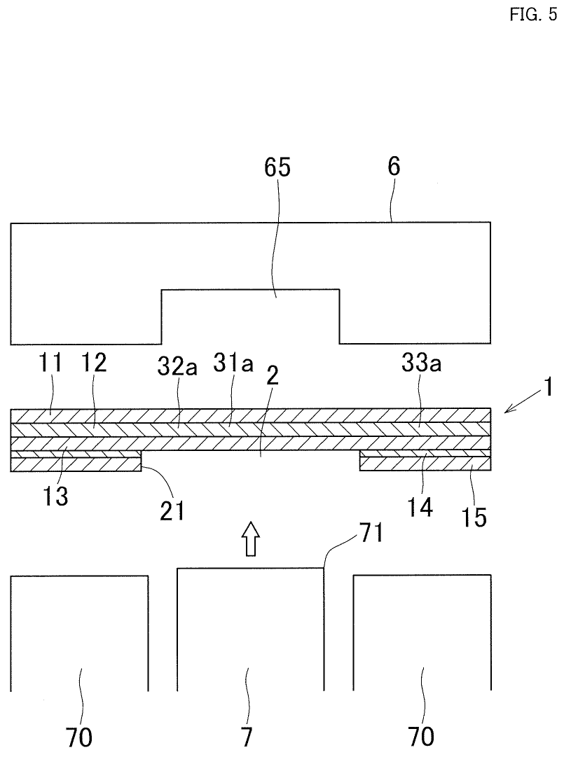

FIG. 5 is a schematic cross-sectional view showing a molding apparatus for forming the case body 3 using the exterior material 1. As shown in the drawing, this molding apparatus includes a die 6 serving as an upper die, and a punch 7 and a wrinkle-preventing die 70 serving as lower dies.

A molding recess 65 for forming the housing portion 35 (bottom wall 31 and sidewall 32) of the case body 3 is formed on the lower surface side of the die 6.

The punch 7 is arranged corresponding to the molding recess 65 of the die 6, and the wrinkle-preventing die 70 is disposed around the outer periphery of the punch 7 so as to face the outer peripheral portion of the lower surface of the die 6.

Then, the sheet-shaped exterior material 1 with an opening portion, serving as a molding material is placed such that its sidewall-intended portion 32a aligns with the outer peripheral edge portion of the tip of the punch 7. In this state, the flange-intended portion 33a of the exterior material 1 is clamped and supported between the outer peripheral portion of the die 6 and the wrinkle-preventing die 70, and the exterior material 1 is press-molded by driving the punch 7 into the molding recess 65 of the die 6. As a result, a molded article (molded material) for the case body is formed, which includes the housing portion 35 (bottom wall 31 and sidewall 32) and a flange 33 extending outward from the housing portion 35. Subsequently, by cutting the flange 33 of the molded article to a predetermined size, the case body 3 of this embodiment is produced. In this case body 3, as shown in FIGS. 1 and 2, the opening portion 2 is disposed over the entire region of the housing portion 35, and the outer peripheral edge portion 21 of the opening portion 2 is disposed on the flange 33.

As described above, since the sealing member 4 has a shape obtained by inverting the case body 3 upside down, it can be formed by the same type of mold forming as described above.

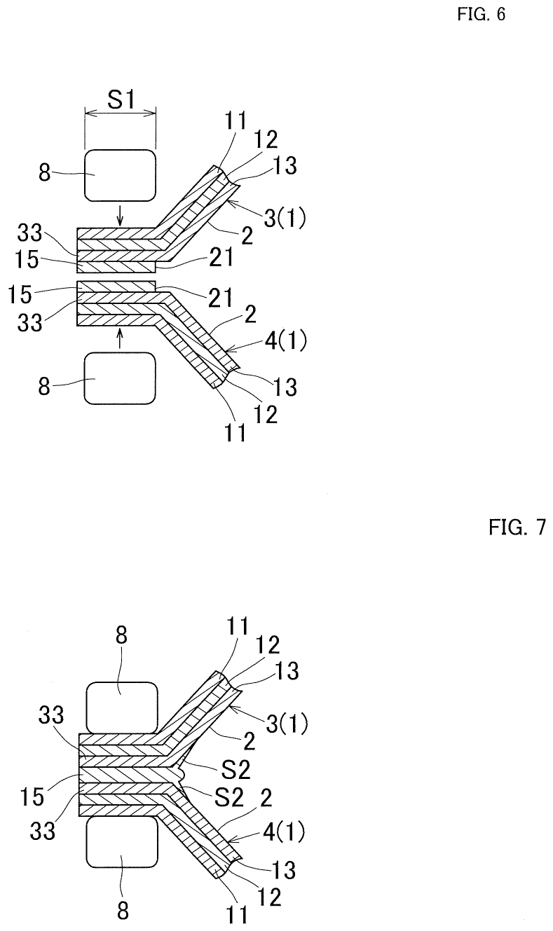

FIG. 6 is a schematic cross-sectional view for explaining a heat sealing method for fabricating the all-solid-state battery by heat sealing the case body 3 and the sealing member 4 in this embodiment. As shown in the figure, in this heat sealing method, a pair of sealing dies 8 is used to heat seal the flanges 33 of the case body 3 and the sealing member 4.

On the other hand, the case body 3 and the sealing member 4, which are to be subjected to heat sealing, are arranged such that an all-solid-state battery cell 5 is housed in the housing portion 35, and the sealant layers 15 of the respective flanges 33 are arranged to face and overlap each other. In that state, as shown in FIG. 7, the flanges 33 of the case body 3 and the sealing member 4 are clamped and heated by a pair of sealing dies 8. As a result, the overlapping sealant layers 15 are heat-sealed and integrally bonded, thereby fabricating an all-solid-state battery in which the all-solid-state battery cell 5 is housed in an airtight state within the case body 3 and the sealing member 4.

In this way, in the heat-sealed all-solid-state battery, the sealant layers 15 of the case body 3 and the sealing member 4 in the heat-sealed portion S1 melt and fuse together. In addition, in the housing portion 35 from the heat-sealed portion S1, a resin accumulation portion S2 is formed by the resin that has melted and flowed out from the sealant layer 15. At this time, resin also melts and flows out from the gas barrier layer 13, thereby forming a large resin accumulation portion S2. Furthermore, this resin accumulation portion S2 is arranged along the gas barrier layers 13 on the inner surfaces of the sidewall 32 of the case body 3 and the sealing member 4, and is in close contact with the gas barrier layers 13 with no clearance.

As described above, in this embodiment, since the resin accumulation portion S2 is large and is further in close contact with the gas barrier layer 13 of the case body 3 and the sealing member 4 without any gaps, no gap is formed between the resin accumulation portion S2 and the gas barrier layer 13. Therefore, peel stress does not concentrate between the sealant layer 15 and the gas barrier layer 13 but instead acts on the heat-sealed portion between the opposing sealant layers 15 of the case body 3 and the sealing member 4.

Accordingly, the occurrence of unintended interlayer delamination due to peel stress can be prevented, and sufficient peel strength (seal strength) can be obtained. The reason for this is that, in this embodiment, the gas barrier layer 13 of the exterior material 1 is made of a resin that can be thermally bonded to the sealant layer 15, such as a polyolefin-based resin.

In this embodiment, the heat-sealed portion S1 refers to a portion, or the portion that has been bonded, where the sealant layers 15 of the case body 3 and the sealing member 4 are thermally bonded (heat-sealed) to each other in a region on the outer peripheral edge portions of the flanges 33 of the case body 3 and the sealing member 4, which are pressed by a pair of sealing dies 8.

Here, in this embodiment, it is preferable to adjust the resin used to form the sealant layer 15 to have an MFR (melt flow rate) of 2 g/10 min to 20 g/10 min (230° C., load 2.16 kgf). That is, when the MFR is within this range, the meltability during heat sealing is improved, making it easier to form a desirable resin accumulation portion S2 as shown in FIGS. 6 and 7, and the seal strength can be improved. In other words, if the MFR is too low, resin flow during heat sealing deteriorates, making it difficult to form the resin accumulation portion and may result in reduced sealability. Furthermore, if the MFR is too high, excessive resin flow may occur during heat sealing, preventing formation of the resin accumulation portion S2 and potentially causing a decline in sealability.

Furthermore, in this embodiment, it is preferable to set the seal strength at the edge portion on the housing portion 35 side (the edge portion on the opening portion 2 side) of the heat-sealed portion S1 to 20 N/15 mm or more. That is, when the seal strength is 20 N/15 mm or more, even if the internal pressure of the all-solid-state battery increases, the seal will not open, thereby maintaining excellent sealing performance and enabling the production of high-quality battery products.

According to the all-solid-state battery of this embodiment having the above-described configuration, since the gas barrier layer 13 is provided between the metal foil layer 12 and the sealant layer 15 in the case body 3 and the sealing member 4, and openings 2 in which part of the sealant layer 15 is removed are formed in the bottom wall 31 and the sidewall 32, heat generated from the all-solid-state battery cell 5 is efficiently transferred and dissipated to the metal foil layer 12 via the opening portions 2 and the gas barrier layer 13 without being blocked by the sealant layer 15, thereby ensuring sufficient heat dissipation and cooling performance.

Particularly in this embodiment, since the outer peripheral edge portion 21 of the opening portion 2 in the case body 3 is set in the flange 33 of the case body 3, it is possible to form a large opening portion 2 covering almost the entire area of the all-solid-state battery cell 5, thereby further improving heat dissipation and cooling performance.

Furthermore, according to the all-solid-state battery of this embodiment, since the gas barrier layer 13 is disposed on the inner surface side of the metal foil layer 12, even if hydrogen sulfide gas or the like is generated due to a reaction between the solid electrolyte of the all-solid-state battery cell 5 and moisture in the outside air, leakage of such gas can be reliably prevented by the gas barrier layer 13. In addition, the gas barrier function of the gas barrier layer 13 also prevents the ingress of moisture such as water vapor from the outside. This suppresses the generation of hydrogen sulfide gas itself due to a reaction between the moisture and the solid electrolyte, and thus more reliably prevents the leakage of hydrogen sulfide gas or the like.

In this embodiment, it is preferable to employ, as the resin used to form the gas barrier layer 13, a material having a water vapor transmission rate of 20 (g/m²/day) or less, as measured in accordance with JIS K7129-1 (humidity sensor method, 40° C., 90% RH). That is, when this configuration is adopted, the ingress of moisture can be more reliably prevented by the gas barrier layer 13, and the generation and leakage of hydrogen sulfide gas can also be more reliably prevented.

In this embodiment, it is preferable to employ, as the resin used to form the gas barrier layer 13, a material having a thermal conductivity of 0.2 W/m·K or higher. That is, when this configuration is adopted, the sufficient thermal conductivity of the gas barrier layer 13 can be achieved, so that the cooling performance of the all-solid-state battery cell 5 can be further improved.

In the all-solid-state battery of this embodiment, the sealant layer 15 is not present between the all-solid-state battery cell 5 and the metal foil layer 12 in the region where the opening portion 2 is formed. However, the insulating gas barrier layer 13 is disposed between them. As a result, insulation can be reliably ensured by the gas barrier layer 13.

In addition, when forming the opening portion 2 in the exterior material 1 by cutting with a laser cutter, rotary blade, or the like (laser cutting, etc.), a damaged portion may be formed at the outer peripheral edge portion 21 of the opening portion due to the laser cutting or the like, which may cause defects such as cracks or pinholes. However, in this embodiment, since the outer peripheral edge portion 21 of the opening portion is formed in the flange 33 of the battery case, it is possible to avoid adverse effects caused by the damaged portion. That is, since the flange 33 is heat-sealed, a resin accumulation portion S2 formed by the heat sealing is formed at the damaged portion (outer peripheral edge portion 21 of the opening portion). Therefore, the damaged portion can be covered and repaired by the resin accumulation portion S2, thereby reliably preventing any adverse effects caused by damage from laser cutting.

In the all-solid-state battery of this embodiment, since the sealant layer 15 is not formed in the portion of the exterior material 1 corresponding to the all-solid-state battery cell 5, the space for accommodating the all-solid-state battery cell 5 can be made larger (thicker) by that amount corresponding to the absence of the sealant layer. Therefore, in the all-solid-state battery of this embodiment, compared to conventional all-solid-state batteries, it is possible to accommodate a larger-sized all-solid-state battery cell 5 without changing the outer dimensions of the case body 3, thereby achieving a thinner structure along with higher output and greater capacity.

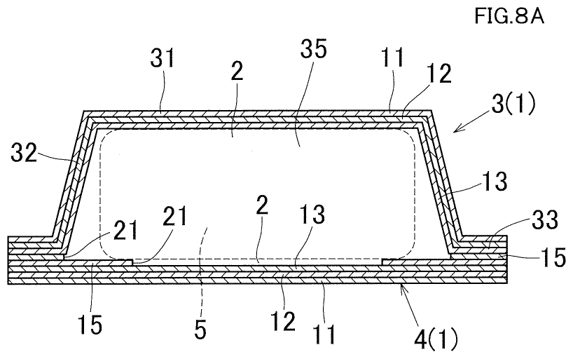

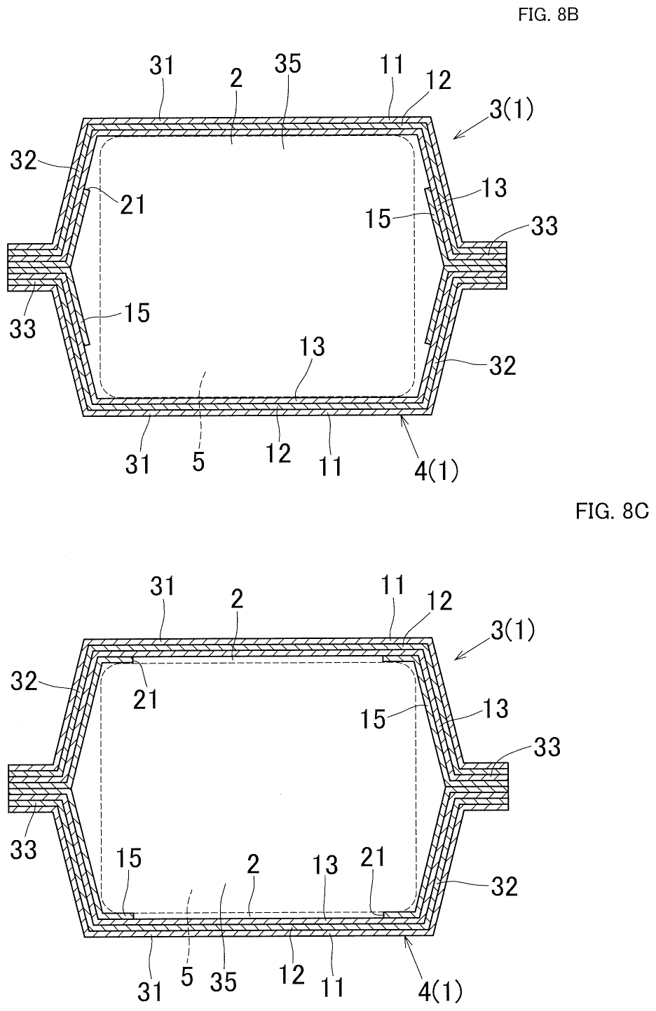

In the all-solid-state battery of the above-described embodiment, a molded article having a shape obtained by inverting the case body 3 is used as the sealing member 4. However, the present disclosure is not limited to this, and a sheet-like non-molded article may be used as the sealing member 4. For example, as shown in FIG. 8A, a sheet-like sealing member 4 may be disposed so as to close the lower end opening portion of the case body 3, and the flange 33 of the case body 3 and the outer peripheral edge portion of the sealing member 4 may be heat-sealed together. Furthermore, in the present disclosure, the all-solid-state battery shown in FIG. 8A may be inverted, that is, the molded case body 3 may be disposed on the lower side, and the sheet-like sealing member 4 on the upper side.

In the above-described embodiment, the opening portion 2 where no sealant layer 15 is present is provided in both the case body 3 and the sealing member 4. However, in the present disclosure, the opening portion 2 may be formed only on the case body 3 side, and the opening portion 2 does not necessarily have to be formed in the sealing member 4.

In the above-described embodiment, the edge portion 21 of the opening portion 2 is set within the flange 33, but the present disclosure is not limited thereto. For example, in the present disclosure, as shown in FIG. 8B, the edge portion 21 of the opening portion 2 may be set on the sidewall 32 of the case body 3 or the sealing member 4, or as shown in FIG. 8C, the edge portion 21 of the opening portion 2 may be set on the bottom wall 33 of the case body 3 or the sealing member 4. That is, in the present disclosure, the shape and size of the opening portion 2 are not particularly limited.

In the above-described embodiment, molded articles are used as the case body 3 and the sealing member 4. However, the present disclosure is not limited thereto, and the case body 3 and the sealing member 4 may each be formed by a sheet-like exterior body. For example, the present disclosure can also be applied to an all-solid-state battery in which an all-solid-state battery cell is sandwiched from above and below by sheet-like exterior bodies, and the all-solid-state battery cell is sealed by heat-sealing the outer peripheral edge portions of the upper and lower sheet-like exterior bodies (the case body and the sealing member).

In the above-described embodiment, an all-solid-state battery has been described as an example of the power storage device of the present disclosure. However, the present disclosure is not limited thereto and can also be applied to other power storage devices, including those other than all-solid-state batteries.

### EXAMPLES

TABLE 1

| | Gas barrier layer | | |
|---|---|---|---|
| | | Melting | Water vapor |
| | | point | transmission |
| | Type · Thickness(μm) | (° C.) | rate (g/m² · D) |
| A1 | CPP(rPP/bPP/rPP = 1.5/7/1.5)25 | 161 | 9 |
| A2 | CPP(rPP/bPP/rPP = 1.5/7/1.5)30 | 161 | 7.5 |
| A3 | CPP(rPP single layer)25 | 165 | 8 |
| A4 | CPP(rPP/bPP/rPP = 1/8/1)30 | 161 | 7.5 |
| A5 | OPP Single layer 15 | 165 | 9.3 |
| A6 | CPP (rPP Single layer)30 | 135 | 8.3 |
| A7 | LDPE 40 Single layer | 105 | 18 |
| A8 | CPP(rPP/bPP/rPP = 1.5/7/1.5)40 | 161 | 5.6 |
| A9 | PET12 | 250 | 48 |
| A10 | ONY15 | 210 | 180 |

TABLE 2

| | Sealant layer | | |
|---|---|---|---|
| | | Melting | Water vapor |
| | | point | transmission |
| | Type · Thickness(μm) | (° C.) | rate (g/m² · D) |
| B1 | CPP(rPP/bPP/rPP = 1.5/7/1.5)80 | 161 | 2.8 |
| B2 | CPP(rPP/bPP/rPP = 1.5/7/1.5)80 | 161 | 2.8 |
| B3 | CPP(rPP/bPP/rPP = 1.5/7/1.5)25 | 161 | 9 |
| B4 | CPP(rPP/bPP/rPP = 1/8/1)80 | 161 | 2.8 |
| B5 | CPP(rPP/bPP/rPP = 1.5/7/1.5)80 | 161 | 2.8 |
| B6 | CPP(rPP/bPP/rPP = 1.5/7/1.5)80 | 161 | 2.8 |
| B7 | LDPE 60 Single layer | 124 | 15 |
| B8 | Maleic anhydride-modified PP50 | 168 | 4 |
| B9 | CPP(rPP/bPP/rPP = 1.5/7/1.5)80 | 161 | 2.8 |
| B10 | CPP(rPP/bPP/rPP = 1.5/7/1.5)80 | 161 | 2.8 |

In Tables 1 and 2, the resin names indicated by abbreviations are as follows:
CPP: Non-stretched polypropylene
bPP: Block polypropylene
rPP: Random polypropylene
hPP: Homopolypropylene
OPP: Biaxially stretched polypropylene
LDPE: Low-density polyethylene
LLDPE: Linear low-density polyethylene
PET: Polyethylene terephthalate
ONY: Biaxially stretched nylon film

As resin films for the gas barrier layer, those shown as A1 to A10 in Table 1 were prepared. For example, the A1 film is a 25 μm-thick, three-layer co-extruded non-stretched polypropylene film, and the layer ratio of this three-layer co-extruded CPP film is lamination layer (rPP)/intermediate layer (bPP)/seal layer (rPP)=1.5/7/1.5. This A1 film was used as the resin film for the gas barrier layer.

Furthermore, as resin films for the sealant layer, those shown as B1 to B10 in Table 2 were prepared.

In Tables 1 and 2, the melting points of the resin films for the gas barrier layer and the sealant layer were measured as the melting peak temperatures obtained by DSC, in accordance with JIS K 7121-1987.

The water vapor transmission rate of the resin films for the gas barrier layer and the sealant layer was measured in accordance with JIS K 7129-1 (humidity sensor method, 40° C., 90% RH).

TABLE 3

| | | | | | Presence or absence of | Seal strength at edge |
|---|---|---|---|---|---|---|
| | | Metal | | | heat-fusibility between | portion of heat-sealed |
| | Base | foil | Gass | | gas barrier layer and | portion (opening |
| | layer | layer | barrier | Sealant | sealant layer | portion) |
| | (μm) | (μm) | layer | layer | (seal strength) | (N/15 mm) |
| Ex. 1 | ONY15 | AL80 | A1 | B1 | ◯ | 96 |
| Ex. 2 | ONY15 | AL80 | A2 | B2 | ◯ | 110 |
| Ex. 3 | ONY15 | AL80 | A3 | B3 | ◯ | 50 |
| Ex. 4 | ONY15 | AL80 | A4 | B4 | ◯ | 103 |
| Ex. 5 | ONY15 | AL80 | A5 | B5 | ◯ | 98 |
| Ex. 6 | ONY15 | AL80 | A6 | B6 | ◯ | 90 |
| Ex. 7 | ONY15 | AL80 | A7 | B7 | ◯ | 118 |
| Ex. 8 | ONY15 | AL80 | A8 | B8 | ◯ | 101 |
| Comp. Ex. 1 | ONY15 | AL80 | A9 | B9 | X | 10 |
| Comp. Ex. 2 | ONY15 | AL80 | A10 | B10 | X | 12 |

1. Confirmation of Thermal Bondability: Presence or Absence of Thermal Bondability between the Gas Barrier Layer and the Sealant Layer.

### Example 1

A gas barrier layer film shown as A1 of Example 1 and a sealant layer film shown as B1 were each cut into a size of 15 mm in width and 150 mm in length. The cut gas barrier layer film and sealant layer film were overlapped, and aluminum foils having a thickness of 80 μm were further laminated on the top and bottom of the overlapped sample to prepare a sample for thermal bonding test. The above heat-sealing sample was heat-sealed using a heat sealer (manufactured by Tester Sangyo Co., Ltd.: TP-701-A) under the following conditions: heat sealing temperature: 200° C.; sealing pressure: 0.2 MPa (gauge pressure); and sealing time: 2 seconds, by double-sided heating, to obtain a seal strength evaluation sample for confirming thermal bondability.

For the above-mentioned seal strength evaluation sample, the peel strength was measured in accordance with JIS Z0238-1998 using a Strograph (AGS-5kNX, manufactured by Shimadzu Access Co., Ltd.) at a tensile speed of 100 mm/min by performing a 180° peel test. The measured peel strength was used as the seal strength (N/15 mm width). The evaluation criteria are as follows. In this evaluation standard, “∘” indicates a pass and “×” indicates a fail. The results are shown in Table 3.
∘: Thermal bondability present (seal strength of 2 N/15 mm or more)
×: Thermal bondability absent (seal strength of less than 2 N/15 mm)

### Examples 2 to 8, Comparative Examples 1 and 2

Using the resin films for the gas barrier layer and the sealant layer shown in Table 3, seal strength evaluation samples for confirming thermal bondability were prepared in the same manner as in Example 1 in Examples 2 to 8 and Comparative Examples 1 and 2, and the seal strengths were similarly measured. The results are shown in Table 3.

### 2. Seal Strength at Opening Edge (Seal Strength at the Edge Portion of the Opening Portion)

### Example 1

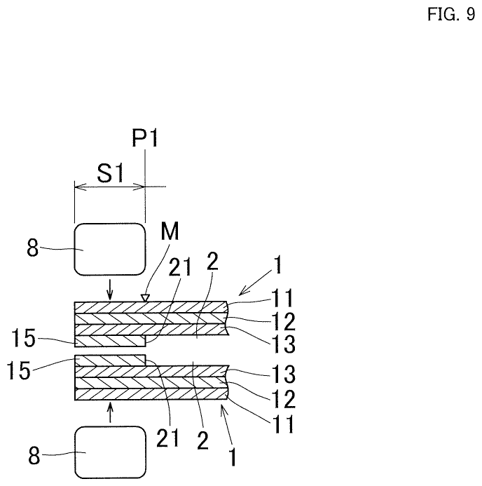

As shown in FIG. 9, a 15 μm-thick ONY was laminated as a base layer 11 onto the outer surface of an 80 μm-thick aluminum foil used as the metal foil layer 12 via a two-component curable polyester-urethane adhesive serving as the first adhesive layer. In addition, a film A1 was laminated as a gas barrier layer 13 onto the inner surface of the metal foil layer 12 via a two-part curing type polyester-urethane adhesive serving as the second adhesive layer. Furthermore, a film B1 was laminated as a sealant layer 15 onto the inner surface of the gas barrier layer 13 via a two-part curing type polyester-urethane adhesive serving as the third adhesive layer. At this time, the third adhesive layer was not applied to the opening-intended portion.

In the exterior material thus obtained, the sealant layer 15 at the opening-intended portion (adhesive-free region) was cut out using a laser cutter to form the opening portion 2.

From the exterior material with the opening portion, two samples of Example 1 having a size of 15 mm in width and 150 mm in length were cut out. In each of these cut samples, the sealant layer 15 was present between one end in the length direction (left end in FIG. 9) and the edge portion 21 of the opening portion 2. The width of the sealant layer 15 (distance from one end in the length direction of the cut sample to the edge portion 21 of the opening) was set to 5 mm.

The two cut samples were arranged to overlap each other such that their respective sealant layers 15 faced one another. Furthermore, a sealing mark M, indicated by a white inverted triangle shown in FIG. 9, was applied at the position of the edge portion 21 of the opening portion 2 on the outer surface (outer surface of the base layer) of the sample.

Subsequently, the sealing mark M on the base layer 11 side of the above-overlapped samples was aligned with the end of the seal bar (sealing die) 8 of the heat sealing apparatus (manufactured by Tester Sangyo Co., Ltd.: TP-701-A), and heat sealing was performed by double-sided heating under the conditions of a heat sealing temperature of 200° C., a sealing pressure of 0.2 MPa (gauge pressure), and a sealing time of 2 seconds, thereby obtaining a seal strength evaluation sample at the opening edge portion.

For the above-described seal strength evaluation sample, the peel strength was measured in accordance with JIS Z0238-1998 using a Strograph (AGS-5kNX, manufactured by Shimadzu Access Co., Ltd.) at a tensile speed of 100 mm/min by performing a 180° peel test. The resulting peel strength was recorded as the seal strength (N/15 mm). The results are shown in Table 3.

### Examples 2 to 8, Comparative Examples 1 and 2

In Examples 2 to 8 and Comparative Examples 1 and 2, seal strength evaluation samples for the opening edge portion were prepared in the same manner as in Example 1, using the resin films for the base layer, aluminum foil, resin films for the gas barrier layer, and resin films for the sealant layer shown in Table 3. The seal strengths were similarly measured.

### 3. Evaluation Results

As is clear from Table 3, the exterior materials of Examples 1 to 8 related to the present disclosure achieved sufficient strength both between the gas barrier layer and the sealant layer and at the opening edge portion. In contrast, the exterior materials of Comparative Examples 1 and 2, which deviate from the essential features of the present disclosure, exhibited lower seal strengths in both aspects compared to those of the examples.

The present application claims priority based on Japanese Patent Application No. 2023-19411 filed on Feb. 10, 2023, and the disclosure of that application is incorporated herein by reference in its entirety.

The terms and expressions used herein are employed for the purpose of explanation and are not intended to be interpreted in a limiting sense. It should be understood that the present disclosure is intended to cover all modifications, equivalents, and alternatives falling within the scope of the appended claims.

It should be understood that the terms and expressions used herein are used for explanation and have no intention to be used to construe in a limited manner, do not eliminate any equivalents of features shown and mentioned herein, and allow various modifications falling within the claimed scope of the present disclosure.

While the present disclosure may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the present disclosure may be embodied in many different forms, a number of illustrative embodiments have been described herein, the present disclosure is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The power storage device exterior material according to the present disclosure can be suitably used as a material for a battery case (casing) for accommodating an all-solid-state battery cell used in an all-solid-state battery or the like.

### DESCRIPTION OF REFERENCE SYMBOLS

1: Exterior material
11: Base layer
12: Metal foil layer
13: Gas barrier layer
15: Sealant layer
2: Opening portion
21: Outer peripheral edge portion
2a: Opening-intended portion
3: Case body
33: Flange
33a: Flange-intended portion
35: Housing portion
4: Sealing member
5: All-solid-state battery cell
10: Adhesive-free region
S1: Heat-sealed portion

1. A power storage device case comprising:
a case body, the case body being provided with a recessed housing portion and a flange provided on an outer periphery of the housing portion,
wherein the case body is made of a power storage device exterior material,
wherein the power storage device exterior material includes a base layer made of resin, a metal foil layer laminated on an inner surface side of the base layer, a gas barrier layer laminated on an inner surface side of the metal foil layer, and a sealant layer laminated on an inner surface side of the gas barrier layer,
wherein the gas barrier layer and the sealant layer are made of resins that are thermally bondable to each other, and
wherein the sealant layer is provided with an opening portion for exposing the gas barrier layer to an inside of the housing portion.

2. A power storage device comprising:
the case body configured to be used in the power storage device case as recited in claim 1;
a power storage device cell housed in the housing portion of the case body; and
a sealing member heat-sealed to the flange of the case body in a state in which an opening portion of the housing portion in the case body is closed.

3. The power storage device as recited in claim 2,
wherein the sealing member includes a base layer made of resin, a metal foil layer laminated on an inner surface side of the base layer, a gas barrier layer laminated on an inner surface side of the metal foil layer, and a sealant layer laminated on an inner surface side of the gas barrier layer, the gas barrier layer and the sealant layer being made of resins thermally bondable to each other, and
wherein the sealant layer in the sealing member is provided with an opening portion for exposing the gas barrier layer of the sealing member to the housing portion.

4. The power storage device as recited in claim 2,
wherein a seal strength at an edge portion of the heat-sealed portion between the flange and the sealing member, the edge portion being located on a housing portion side, is set to 20 N/15 mm or more.

5. The power storage device as recited in claim 3,
wherein a seal strength at an edge portion of the heat-sealed portion between the flange and the sealing member, the edge portion being located on a housing portion side, is set to 20 N/15 mm or more.

6. A power storage device exterior material configured to be used in the power storage device case as recited in claim 1,
wherein the power storage device exterior material has a sheet-like shape, and
wherein the power storage device exterior material is provided with an opening-intended portion to serve as the opening portion and a flange-intended portion to serve as the flange.

7. The power storage device exterior material as recited in claim 6,
wherein an adhesive layer is provided between the gas barrier layer and the sealant layer, and
wherein the opening-intended portion is configured as an adhesive-free portion in which the adhesive layer is not present.

8. The power storage device exterior material as recited in claim 6,
wherein the gas barrier layer and the sealant layer are made of a polyolefin-based resin.

9. The power storage device exterior material as recited in claim 7,
wherein the gas barrier layer and the sealant layer are made of a polyolefin-based resin.
